(19) United States
(12) Patent Application Publication
(10) Pub. No.: US 2018/0204523 A1
(43) Pub. Date: Jul. 19, 2018

(54) DISPLAY DEVICE, METHOD OF DRIVING DISPLAY DEVICE, AND METHOD OF INSPECTING DISPLAY DEVICE

(71) Applicant: Japan Display Inc., Minato-ku (JP)

(72) Inventors: Tsutomu HARADA, Tokyo (JP); Kazuhiko SAKO, Tokyo (JP)

(73) Assignee: Japan Display Inc., Minato-ku (JP)

(21) Appl. No.: 15/841,395

(22) Filed: Dec. 14, 2017

(30) Foreign Application Priority Data
Jan. 19, 2017 (JP) 2017-007592

(51) Int. Cl. G09G 3/34; G09G 3/36; G09G 3/00

(52) U.S. Cl. CPC G09G 3/342; G09G 3/36; G09G 2320/0233; G09G 2320/0646; G09G 2310/08; G09G 3/006

(57) ABSTRACT

According to one embodiment, a display device includes an illumination device includes a first illumination portion and a second illumination portion, a display panel includes a first display portion illuminated by the first illumination portion, and a second display portion illuminated by the second illumination portion, and a controller which controls the illumination device and the display panel, wherein the first display portion includes a first sub-display portion, and a second sub-display portion adjacent to the second display portion, and the controller controls a modulation rate of the second sub-display portion of the first display portion, based on an amount of displacement between the illumination device and the display panel.

### CROSS-REFERENCE TO RELATED APPLICATIONS

This application is based upon and claims the benefit of priority from Japanese Patent Application No. 2017-007592, filed Jan. 19, 2017, the entire contents of which are incorporated herein by reference.

### FIELD

Embodiments described herein relate generally to a display device, a method of driving the display device and a method of inspecting the display device.

### BACKGROUND

Recently, in a display device comprising a liquid crystal display panel and an illumination device which can be driven for each region in a divided manner, a technology of driving the illumination device based on an image signal, and correcting the image signal to be supplied to the liquid crystal display panel has been proposed.

### BRIEF DESCRIPTION OF THE DRAWINGS

FIG. 1 is a block diagram showing the structure of a display device DSP according to the present embodiment.

FIG. 2 is an exploded perspective view showing a configuration example of the display device DSP according to the present embodiment.

FIG. 3 is an illustration showing a basic structure and an equivalent circuit of a display panel PNL shown in FIG. 1.

FIG. 4 is an illustration showing a cross section of the display device DSP shown in FIG. 1 along a first direction X.

FIG. 5 is an illustration for explaining a method of inspecting the display device DSP which is applicable to the present embodiment.

FIG. 6 is an illustration showing a state in which an inspection screen is displayed on the display device DSP where displacement amount ΔX is zero.

FIG. 7 is an illustration for explaining each portion of the display device DSP shown in FIG. 6.

FIG. 8 is an illustration showing a state in which the inspection screen is displayed on the display device DSP in which an illumination device IL and the display panel PNL are displaced from each other in the first direction X.

FIG. 9 is an illustration for explaining each portion of the display device DSP shown in FIG. 8.

FIG. 10 is an illustration showing a state in which the inspection screen is displayed on the display device DSP where displacement amount ΔY is zero.

FIG. 11 is an illustration for explaining each portion of the display device DSP shown in FIG. 10.

FIG. 12 is an illustration showing a state in which the inspection screen is displayed on the display device DSP in which the illumination device IL and the display panel PNL are displaced from each other in a second direction Y.

FIG. 13 is an illustration for explaining each portion of the display device DSP shown in FIG. 12.

FIG. 14 is an illustration for explaining a method of driving the display device DSP according to the present embodiment.

FIG. 15 shows an example of brightness distribution data stored in a memory 112.

FIG. 16 is an illustration showing one example of a brightness profile calculated by an image processor 111.

FIG. 17 is an illustration for explaining a state in which a positional relationship between an illumination portion and a display portion is shifted in the first direction X.

FIG. 18 is an illustration for explaining a state in which the positional relationship between the illumination portion and the display portion is shifted in the second direction Y.

FIG. 19 is an illustration showing another configuration example of the illumination device IL and the display panel PNL which can be applied to the present embodiment.

### DETAILED DESCRIPTION

In general, according to one embodiment, a display device includes: an illumination device comprising a first illumination portion and a second illumination portion which are adjacent to each other; a display panel comprising a first display portion illuminated by the first illumination portion, and a second display portion illuminated by the second illumination portion, the display panel being fixed to the illumination device; and a controller which controls the illumination device and the display panel, wherein the first display portion includes a first sub-display portion, and a second sub-display portion adjacent to the second display portion, and the controller controls a modulation rate of the second sub-display portion of the first display portion, based on an amount of displacement between the illumination device and the display panel.

According to another embodiment, a method of driving a display device, the display device includes: an illumination device comprising a first illumination portion and a second illumination portion which are adjacent to each other; and a display panel including a first display portion illuminated by the first illumination portion, and a second display portion illuminated by the second illumination portion, the first display portion including a first sub-display portion, and a second sub-display portion adjacent to the second display portion, the method of driving the display device including controlling a modulation rate of the second sub-display portion of the first display portion, based on an amount of displacement between the illumination device and the display panel.

According to yet another embodiment, a method of inspecting a display device, the method includes: displaying an inspection screen on the display device including an illumination device and a display panel fixed to the illumination device; measuring an amount of displacement between the illumination device and the display panel based on a brightness distribution of the displayed inspection screen; and writing an adjustment parameter based on the amount of displacement to the display device, the displaying the inspection screen including: setting a first illumination portion of the illumination device to a first brightness level, and setting a second illumination portion adjacent to the first illumination portion to a second brightness level; and driving a first display portion of the display panel based on a first video signal, and driving a second display portion adjacent to the first display portion based on a second video signal, wherein the first brightness level is different from the second brightness level, and the first video signal is different from the second video signal.

Embodiments are described with reference to accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are illustrated in the drawings schematically, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, and redundant detailed description thereof is omitted unless necessary.

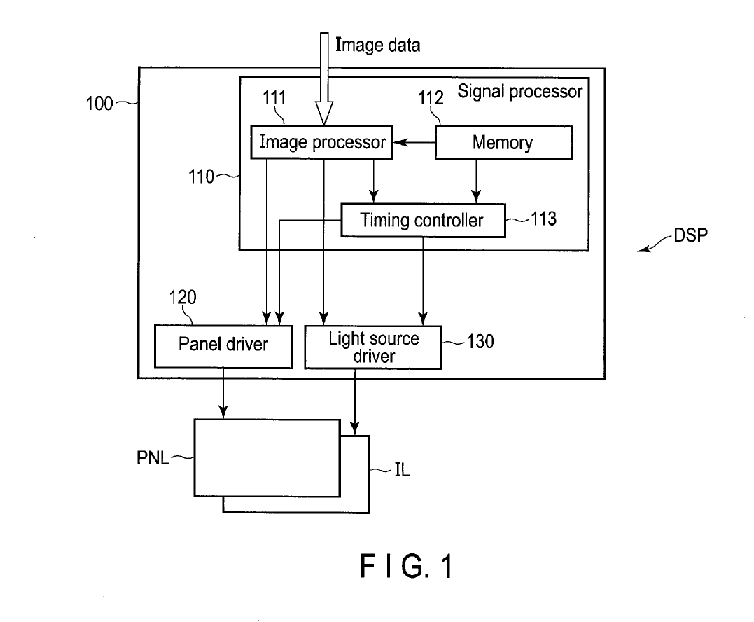

FIG. 1 is a block diagram showing the structure of a display device DSP according to the present embodiment.

The display device DSP comprises a controller 100, a display panel PNL, and an illumination device IL. The controller 100 manages control of the display panel PNL and the illumination device IL. The details of the display panel PNL and the illumination device IL will be described later.

The controller 100 comprises a signal processor 110, a panel driver 120, and a light source driver 130. The signal processor 110 comprises an image processor 111, a memory 112, and a timing controller 113. In the signal processor 110, image data corresponding to an image which should be displayed on the display panel PNL is input. The image processor 111 processes the input image data, and outputs a control signal to each of the timing controller 113, the panel driver 120, and the light source driver 130. The timing controller 113 processes the control signal input from the image processor 111, and outputs a control signal to each of the panel driver 120 and the light source driver 130. A program necessary for generating various control signals in the image processor 111 and the timing controller 113, brightness distribution data for each of light sources of a light source unit which will be described later, an adjustment parameter according to a displacement amount which will be described later, etc., are stored in the memory 112. The control signal output from the image processor 111 to the panel driver 120 includes a video signal for driving each pixel of the display panel PNL at a predetermined gradation value or a corrected video signal. The control signal output from the timing controller 113 to the panel driver 120 includes a synchronization signal. The control signal output from the image processor 111 to the light source driver 130 includes a drive signal for driving the light source of the illumination device IL at a predetermined brightness level. The control signal output from the timing controller 113 to the light source driver 130 includes a synchronization signal which synchronizes a timing at which the pixel is driven and a timing at which the light source is driven.

The panel driver 120 controls a modulation rate (transmittance or reflectance) of the display panel PNL based on the control signals from the image processor 111 and the timing controller 113. The light source driver 130 controls driving of the illumination device IL based on the control signals from the image processor 111 and the timing controller 113.

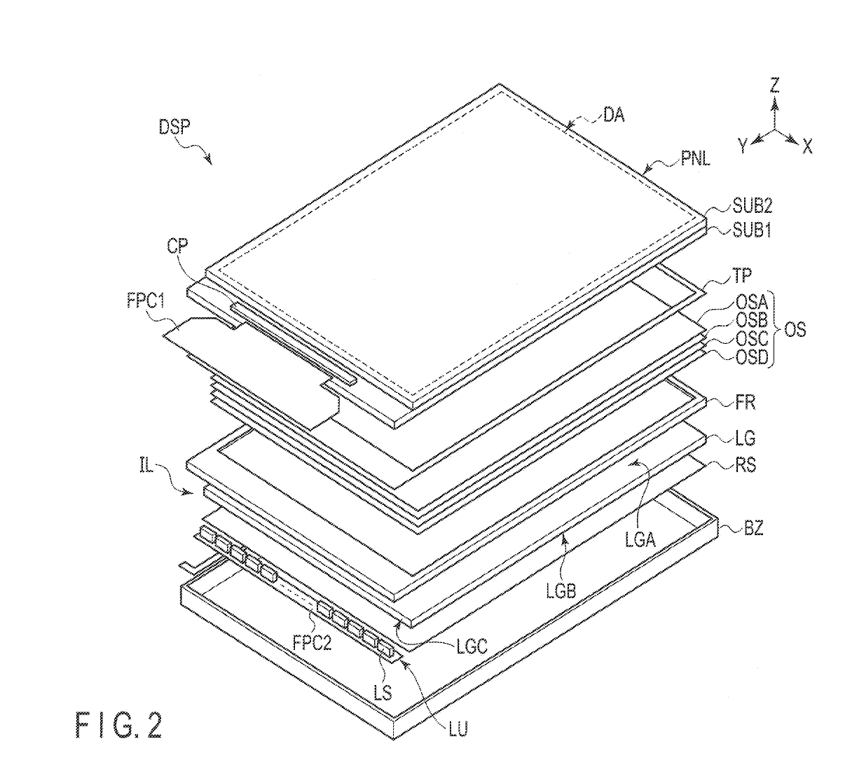

FIG. 2 is an exploded perspective view showing a configuration example of the display device DSP according to the present embodiment. In the figure, a first direction X and a second direction Y are directions intersecting each other, and a third direction Z is a direction intersecting the first direction X and the second direction Y. In one example, while the first direction X, the second direction Y, and the third direction Z are orthogonal to each other, they may cross each other at an angle other than 90 degrees. In the present specification, a direction toward a pointing end of an arrow indicating the third direction Z is referred to as upward (or merely above), and a direction toward the opposite side from the pointing end of the arrow is referred to as downward (or merely below). Further, it is assumed that an observation position at which the display device DSP is to be observed is at the pointing end side of the arrow indicating the third direction Z, and a view toward an X-Y plane defined by the first direction X and the second direction Y from this observation position is called a planar view.

The display device DSP comprises an active-matrix-type display panel PNL, the illumination device IL which illuminates the display panel PNL, and a double-sided tape TP which fixes the display panel PNL and the illumination device IL together. The illumination device IL comprises an optical sheet OS, a frame FR, a light-guide LG, a light source unit LU, a reflection sheet RS, a bezel BZ, etc.

The display panel PNL includes a first substrate SUB1, a second substrate SUB2 opposed to the first substrate SUB1, and a liquid crystal layer held between the first substrate SUB1 and the second substrate SUB2. The liquid crystal layer is not shown because it is much thinner than the display panel PNL and is located inside a sealant with which the first and second substrates SUB1 and SUB2 are stuck together. The display panel PNL includes a display area DA which displays an image in an area in which the first substrate SUB1 and the second substrate SUB2 are opposed to each other. In the example illustrated, the display area DA is formed in a rectangular shape. The display panel PNL is a transmissive display panel having a transmissive display function of displaying an image by selectively transmitting light from the illumination device IL. Note that the display panel PNL may have a reflective display function of displaying an image by selectively reflecting external light, in addition to the transmissive display function. Also, in the present embodiment, any one of a display mode which uses a lateral electric field substantially parallel to a substrate main surface, a display mode which uses a longitudinal electric field substantially perpendicular to the substrate main surface, a display mode which uses an inclined electric field tilted with respect to the substrate main surface, and a display mode which uses a combination of the aforementioned display modes can be applied. The substrate main surface mentioned above is a surface parallel to the X-Y plane.

In the example illustrated, an IC chip CP and a flexible printed circuit FPC1 are mounted on the first substrate SUB1 as signal supply sources which supply signals necessary for driving the display panel PNL.

The light-guide LG is located between the frame FR and the bezel BZ. In the example illustrated, the light-guide LG is formed in a flat plate shape, and includes a first main surface LGA, a second main surface LGB on the opposite side of the first main surface LGA, and a side surface LGC. The first main surface LGA and the second main surface LGB are both parallel to the X-Y plane, and the side surface LGC is parallel to an X-Z plane.

The light source unit LU is arranged along the side surface LGC. The light source unit LU comprises a plurality of light sources LS, a flexible printed circuit FPC2 on which the light sources LS are mounted, and the like. The light source LS is, for example, a light-emitting diode. The light sources LS are arranged in the first direction X, and emit light toward the side surface LGC.

The reflective sheet RS has light reflectivity, and is located between the bezel BZ and the second main surface LGB of the light-guide LG.

The optical sheet OS includes a diffusion sheet OSA, a prism sheet OSB, a prism sheet OSC, a diffusion sheet OSD, etc. The sheets in the optical sheet OS are stacked in the third direction Z, and are located between the display panel PNL and the first main surface LGA of the light-guide LG.

The frame FR is located between the display panel PNL and the bezel BZ. In the example illustrated, the frame FR is formed in a rectangular frame shape.

The double-sided tape TP is located between the display panel PNL and the illumination device IL outside the display area DA, and bonds the display panel PNL and the illumination device IL. The double-sided tape TP is formed in a rectangular frame shape, for example.

The bezel BZ accommodates the display panel PNL and the illumination device IL described above. In the example illustrated, the illumination device IL functions as a backlight unit which illuminates the display panel PNL from a rear side, that is, a side opposed to the first substrate SUB1.

The light emitted from the light source LS passes through the optical sheet OS after being propagated through the light-guide LG, and is guided to the display panel PNL. At this time, the brightness level of each of the light sources LS is independently controlled by the magnitude of a current to be supplied and pulse-width modulation driving. The illumination device IL which illuminates the display panel PNL with light transmitted through the light-guide LG from the respective light sources LS can form regions for which the brightness levels can be set individually in the X-Y plane as a result of control over each of these light sources LS. For example, as the brightness levels of the light sources LS arranged in the first direction X are controlled independently, the illumination device IL can set the brightness levels independently in the regions arranged in the first direction X. Also, a single light source LS can be controlled such that a brightness distribution in which the brightness levels are varied in a direction of travel of light emitted toward the light-guide LG (i.e., in the direction opposite to that indicated by an arrow representing the second direction Y in the drawing) is formed. As a result of control over such a brightness distribution, the illumination device IL can set the brightness levels independently in regions arranged in the second direction X. The region for which the brightness level can be set in the illumination device IL corresponds to an illumination portion which will be described later. Note that in the present embodiment, with respect to the brightness level of the light source LS or the brightness level of the illumination portion, it is assumed that the maximum brightness level is 100% and the minimum brightness level is 0% in a range of values of current supplied to the light source LS.

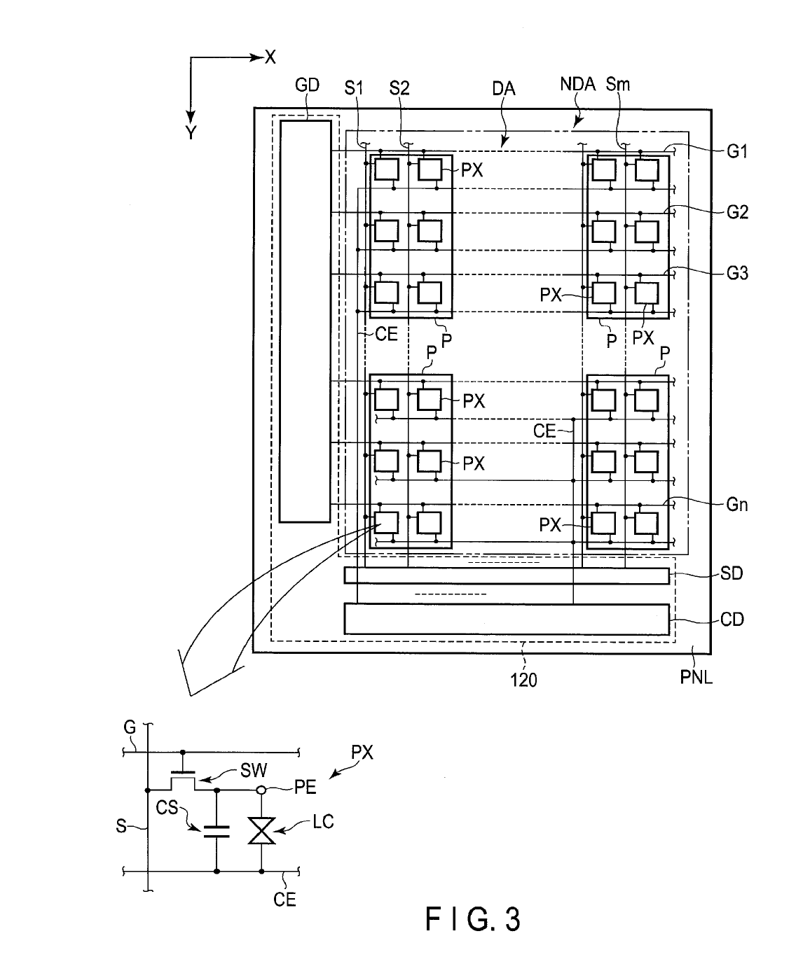

FIG. 3 is an illustration showing a basic structure and an equivalent circuit of the display panel PNL shown in FIG. 1. The display panel PNL includes pixels PX in the display area DA. The pixels PX are arrayed in a matrix in the first direction X and the second direction Y. Also, the display panel PNL includes scanning lines G (G1 to Gn), signal lines S (S1 to Sm), a common electrode CE, etc., in the display area DA. The scanning lines G extend in the first direction X, and are arranged to be spaced apart from each other in the second direction Y. The signal lines S extend in the second direction Y, and are arranged to be spaced apart from each other in the first direction X. Note that the scanning lines G and the signal lines S do not necessarily extend linearly, and may be partially bent. Even if the scanning lines G and the signal lines S are partially bent, it is assumed that they extend in the first direction X and the second direction Y. The common electrode CE is disposed over the pixels PX.

The panel driver 120 comprises a signal line drive circuit SD, a scanning line drive circuit GD, and a common electrode drive circuit CD. The scanning lines G are connected to the scanning line drive circuit GD. The signal lines S are connected to the signal line drive circuit SD. The common electrode CE is connected to the common electrode drive circuit CD. The signal line drive circuit SD, the scanning line drive circuit GD, and the common electrode drive circuit CD may be formed on the first substrate SUB1 shown in FIG. 2 in the non-display area NDA. Alternatively, some of these circuits or all of these circuits may be incorporated in the IC chip CP shown in FIG. 2, or may be incorporated in an IC chip separately mounted on the flexible printed circuit FPC1.

Each of the pixels PX comprises a switching element SW, a pixel electrode PE, the common electrode CE, a liquid crystal layer LC, and the like. The switching element SW is constituted by a thin-film transistor (TFT), for example, and is electrically connected to the scanning line G and the signal line S. The scanning line G is connected to the switching elements SW of the respective pixels PX arranged in the first direction X. The signal line S is connected to the switching elements SW of the respective pixels PX arranged in the second direction Y. The pixel electrode PE is electrically connected with the switching element SW. Each of the pixel electrodes PE is opposed to the common electrode CE. The liquid crystal layer LC is driven by an electric field produced between the pixel electrode PE and the common electrode CE. A storage capacitance CS is formed between, for example, an electrode having the same potential as that of the common electrode CE and an electrode having the same potential as that of the pixel electrode PE.

The display panel PNL comprises a display portion P composed of a plurality of pixels PX. For example, the display portion P is composed of a×b pixels, where a is the number of pixels PX arranged in the first direction X, and b is the number of pixels PX arranged in the second direction Y. Note that a and b are both integers greater than or equal to 1. A plurality of display portions P are arrayed in a matrix in the first direction X and the second direction Y. A video signal is written to the pixel PX, and the pixel PX is driven at a predetermined gradation value. In a transmissive display panel PNL, a minimum transmittance of the display panel PNL can be allocated to a minimum gradation value, a maximum transmittance can be allocated to a maximum gradation value, and intermediate transmittances can be allocated to halftone values in a range of voltages applied to the liquid crystal layer LC. Note that in a reflective display panel PNL, reflectances can be allocated to the gradation values, respectively. In a liquid crystal display panel, the transmittance or the reflectance is varied according to the magnitude of a liquid crystal application voltage. In the present specification, these transmittances and reflectances may be referred to as a modulation rate of the display panel.

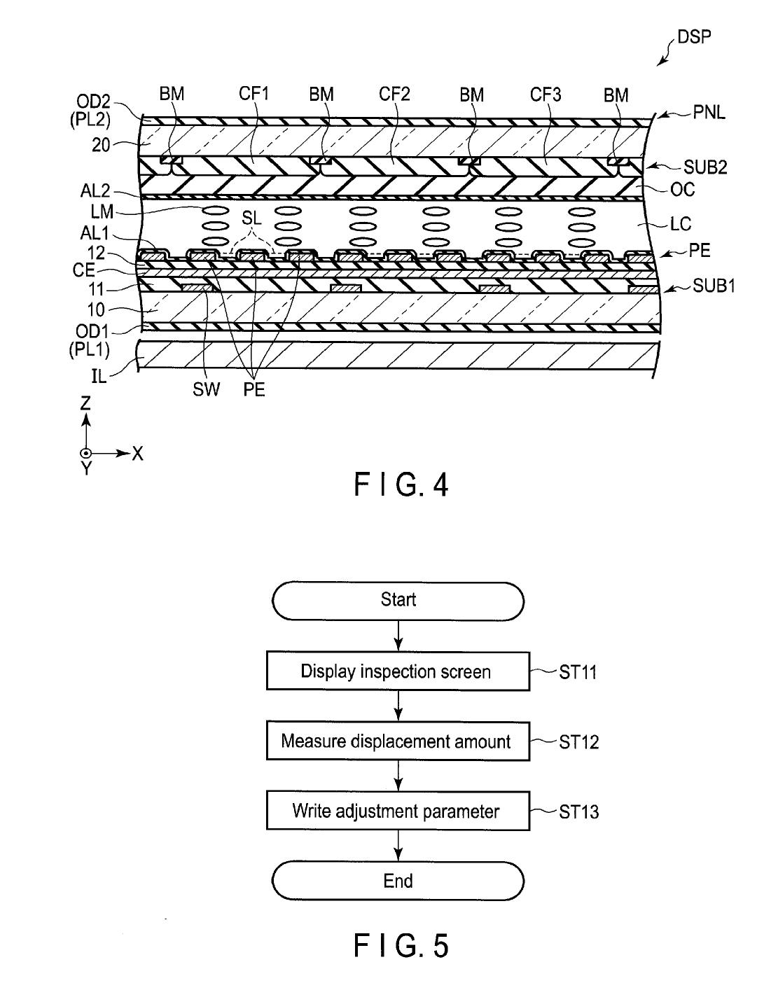

FIG. 4 is an illustration showing a cross section of the display device DSP shown in FIG. 1 along the first direction X. The example illustrated corresponds to a liquid crystal display device of a display mode using a lateral electric field as an example of the display device DSP.

The display panel PNL comprises a first optical element OD1, a second optical element OD2, the first substrate SUB1, the second substrate SUB2, the liquid crystal layer LC, etc. The first substrate SUB1, the second substrate SUB2, and the liquid crystal layer LC are located between the first optical element OD1 and the second optical element OD2. The liquid crystal layer LC is located between the first substrate SUB1 and the second substrate SUB2. The first optical element OD1 comprises a first polarizer PL1. The second optical element OD2 comprises a second polarizer PL2. An absorption axis of the first polarizer PL1 and an absorption axis of the second polarizer PL2 are orthogonal to each other in the X-Y plane, for example.

The first substrate SUB1 comprises a first insulating substrate 10, the switching element SW, a first insulating film 11, the common electrode CE, a second insulating film 12, the pixel electrode PE, a first alignment film AL1, and the like. The first insulating substrate 10 is a glass substrate, a resin substrate, or the like. The switching element SW is located on the first insulating substrate 10. The first insulating film 11 is located on the first insulating substrate 10 and the switching element SW. The common electrode CE is located on the first insulating film 11. The second insulating film 12 is located on the common electrode CE. The pixel electrode PE is located on the second insulating film 12, and is opposed to the common electrode CE via the second insulating film 12. Slits SL are formed in the pixel electrode PE. The pixel electrode PE is electrically connected with the switching element. The common electrode CE and the pixel electrode PE are formed of a transparent conductive material such as indium-tin-oxide (ITO) or indium-zinc-oxide (IZO)). The first alignment film AL1 covers the second insulating film 12 and the pixel electrode PE.

The second substrate SUB2 comprises a second insulating substrate 20, a light-shielding layer BM, color filters CF1 to CF3, an overcoat layer OC, a second alignment film AL2, and the like. The second insulating substrate 20 is a glass substrate, a resin substrate, or the like. The light-shielding layer BM and the color filters CF1 to CF3 are located in the second insulating substrate 20, at the side opposed to the first substrate SUB1. The color filters CF1 to CF3 are, for example, a red color filter, a green color filter, and a blue color filter, respectively, but the other colors may be applied, and a white color layer or a transparent layer may further be added. The red color filter CF1 is disposed in a red pixel (R) that displays red, the green color filter CF2 is disposed in a green pixel (G) that displays green, and the blue color filter CF3 is disposed in a blue pixel (B) that displays blue. Also, the white color layer or the transparent layer is disposed in a white pixel (W) that substantially displays white. The overcoat layer OC covers the color filters CF1 to CF3. The second alignment film AL2 covers the overcoat layer OC. The first alignment film AL1 and the second alignment film AL2 exhibit, for example, horizontal alignment properties of aligning liquid crystal molecules LM included in the liquid crystal layer LC in a direction substantially parallel to the substrate main surface. The liquid crystal layer LC is located between the first alignment film AL1 and the second alignment film AL2.

FIG. 5 is an illustration for explaining a method of inspecting the display device DSP which is applicable to the present embodiment. Here, a lighting inspection of the display device DSP in which the illumination device IL and the display panel PNL are fixed to each other is described.

First, an inspection screen (or an inspection pattern) is displayed on the display device DSP (step ST11). While an example of steps of displaying the inspection screen is to be described later, in the illumination device IL, the illumination portions adjacent to each other are set to different brightness levels. Further, in the display panel PNL, the display portions adjacent to each other are driven based on different video signals, and are set to different transmittances.

Next, a brightness distribution of the inspection screen displayed in the display area DA is measured, and an amount of displacement between the illumination device IL and the display panel PNL is measured, on the basis of the measured brightness distribution (step ST12). While a specific example of the steps of measuring the displacement amount is to be described later, for example, the displacement amount can be measured by comparing the brightness distribution of the inspection screen displayed when the displacement amount is zero and the measured brightness distribution. Here, displacement amount ΔX, which is the displacement along the first direction X, and displacement amount ΔY, which is the displacement along the second direction Y, can be measured. The brightness distribution of the display area DA can be obtained based on the brightness level of the illumination portion and the transmittance of the display portion, for example.

Next, an adjustment parameter based on the measured displacement amount is written into the display device DSP (step ST13). For example, the adjustment parameter can be obtained by expressing each of the lengths corresponding to displacement amount ΔX and displacement amount ΔY with the number of pixels. For example, when a width of a main pixel (including the red pixel, the green pixel, and the blue pixel) of the display panel PNL along the first direction X is 100 μm, and the measured displacement amount ΔX is 200 μm, the adjustment parameter is calculated as “two pixels” (an amount equivalent to two pixels) in the first direction X. The adjustment parameter is stored in the memory 112 described with reference to FIG. 1, for example.

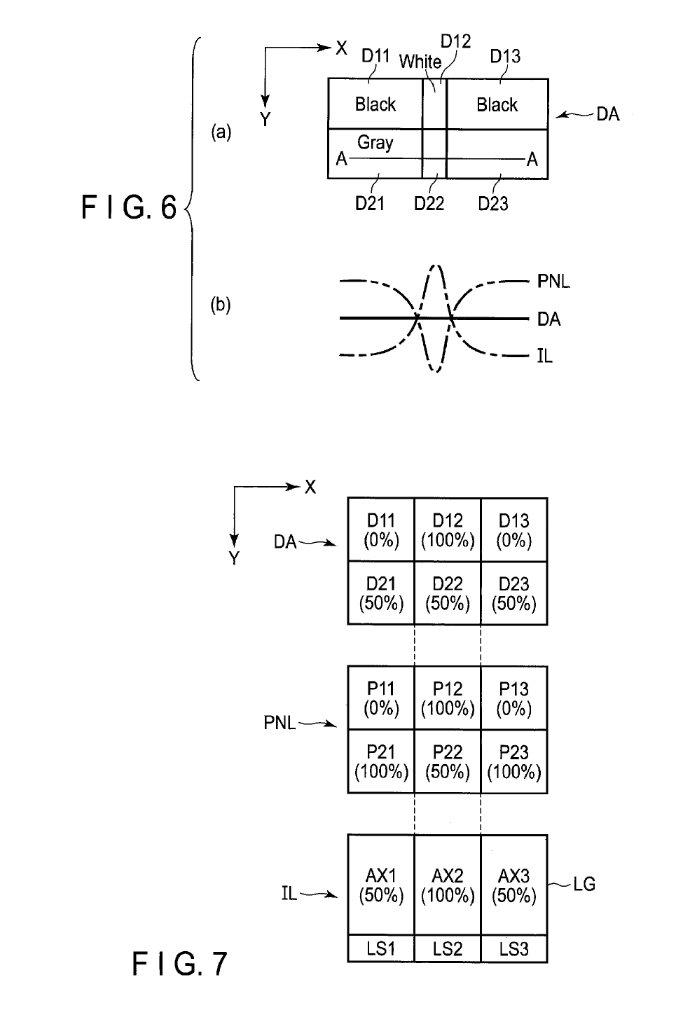

FIG. 6 is an illustration showing the state in which the inspection screen is displayed on the display device DSP where displacement amount ΔX is zero. FIG. 6(a) is an illustration showing the display area DA in which the inspection screen is displayed, and FIG. 6(b) is an illustration showing each of the brightness distribution along line A-A of the display area DA shown in FIG. 6(a) (indicated by a solid line), the brightness distribution of the illumination device IL (indicated by a one-dot chain line), and the transmittance distribution of the display panel PNL (indicated by a two-dot chain line).

The display area DA includes region D11 to D13 and regions D21 to D23 arranged in the first direction X. Regions D11 and D21 are arranged in the second direction Y, regions D12 and D22 are arranged in the second direction Y, and regions D13 and D23 are arranged in the second direction Y. In a state in which the inspection screen is displayed in the display area DA, a white image (maximum gradation value) is displayed in region D12, a black image (minimum gradation value) is displayed in regions D11 and D13, and a gray image (halftone value) is displayed in regions D21 to D23.

In the illumination device IL, the brightness level of light directed toward region D12 and the brightness level of light directed toward regions D11 and D13 are controlled such that the white image is displayed in region D12 and the black image is displayed in regions D11 and D13. Here, since the light traveling toward regions D11 and D13 also passes through regions D21 and D23, respectively, the light directed toward regions D11 and D13 is controlled to a brightness level necessary for displaying the gray image in regions D21 and D23. Meanwhile, the display panel PNL is controlled to have a transmittance in consideration of the brightness level of the illumination device IL. Thereby, regions D21 to D23 show a gray image of a substantially uniform brightness distribution. Such control will be explained specifically with reference to FIG. 7.

FIG. 7 is an illustration for explaining each portion of the display device DSP shown in FIG. 6. Here, parts in the X-Y plane are depicted schematically for each of the illumination device IL, the display panel PNL, and the display area DA. The illumination device IL comprises illumination portions AX1 to AX3 arranged in the first direction X. Light sources LS1 to LS3 are arranged in the first direction X, and each emit light toward the light-guide LG in a direction opposite to that indicated by the arrow representing the second direction Y. In the example illustrated, it is assumed that light sources LS1 to LS3 illuminate illumination portions AX1 to AX3, respectively. The display panel PNL comprises display portions P11 to P13 arranged in the first direction X, and display portions P21 to P23 arranged in the first direction X. Each of these display portions P11 to P13 and display portions P21 to P23 is composed of a plurality of pixels PX arrayed in a matrix, as has been explained referring to FIG. 3, etc. Display portions P11 and P21 are arranged in the second direction Y, and both of them overlap the illumination portion AX1 and are illuminated by illumination portion AX1. Display portions P12 and P22 are arranged in the second direction Y, and both of them overlap the illumination portion AX2 and are illuminated by illumination portion AX2. Display portions P13 and P23 are arranged in the second direction Y, and both of them overlap the illumination portion AX3 and are illuminated by illumination portion AX3.

In one example, brightness levels of illumination portions AX1 and AX3 are each set to 50%, and a brightness level of illumination portion AX2 is set to 100%. Here, it is assumed that the brightness level along the first direction X and the second direction Y is kept constant for each of illumination portions AX1 to AX3.

A transmittance of each of display portions P11 and P13 is set to 0%, a transmittance of each of display portions P12, P21, and P23 is set to 100%, and a transmittance of display portion P22 is set to 50%.

A brightness level of each region in the display area DA can be expressed by, for example, the product of the brightness level of the illumination portion and the transmittance of the display portion. The brightness levels of regions D11 and D13 are 0% because the transmittances of the corresponding display portions P11 and P13 are 0%. The brightness level of region D12 is 100% because the transmittance of the corresponding display portion P12 is 100%, and the brightness level of illumination portion AX2 is 100%. Consequently, a black image corresponding to the minimum gradation value is displayed in each of regions D11 and D13, and a white image corresponding to the maximum gradation value is displayed in region D12.

The brightness levels of region D21 and D23 are 50% because the transmittances of the corresponding display portions P21 and P23 are 100%, and the brightness levels of illumination portions AX1 and AX3 are 50%. The brightness level of region D22 is 50% because the transmittance of the corresponding display portion P22 is 50%, and the brightness level of illumination portion AX2 is 100%. Consequently, a gray image corresponding to a halftone is displayed in regions D21 to D23, and the brightness levels of regions D21 to D23 become uniform.

As can be seen, the brightness distribution of the inspection screen explained with reference to FIGS. 6 and 7 corresponds to a first brightness distribution obtained when displacement amount ΔX, which is measured in step ST12 explained referring to FIG. 5, is zero, and this first brightness distribution can be used as a criterion in measuring displacement amount ΔX.

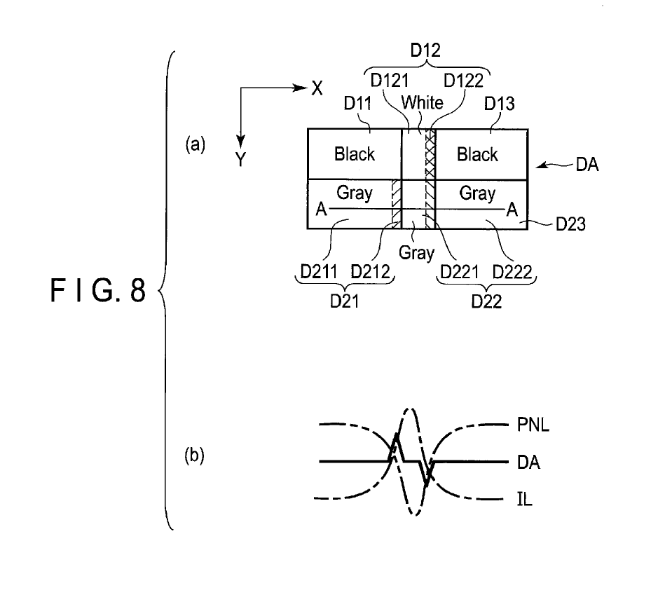

FIG. 8 is an illustration showing the state in which the inspection screen is displayed on the display device DSP in which the illumination device IL and the display panel PNL are displaced from each other in the first direction X. FIG. 8(a) is an illustration showing the display area DA in which the inspection screen is displayed, and FIG. 8(b) is an illustration showing each of the brightness distribution along line A-A of the display area DA shown in FIG. 8(a) (indicated by a solid line), the brightness distribution of the illumination device IL (indicated by a one-dot chain line), and the transmittance distribution of the display panel PNL (indicated by a two-dot chain line).

As shown in FIG. 8(a), region D12 includes sub-region D121 adjacent to region D11, and sub-region D122 adjacent to region D13. In the example illustrated, while a white image is displayed in sub-region D121 as in the example illustrated in FIG. 6, an image of a gradation value different from that of the white image is displayed in sub-region D122.

Similarly, region D21 includes sub-regions D211 and D212, and sub-region D212 is adjacent to region D22. In the example illustrated, while a gray image is displayed in sub-region D211, an image of a gradation value different from that of the gray image is displayed in sub-region D212.

Similarly, region D22 includes sub-regions D221 and D222, and sub-region D222 is adjacent to region D23. In the example illustrated, while a gray image is displayed in sub-region D221, an image of a gradation value different from that of the gray image is displayed in sub-region D222.

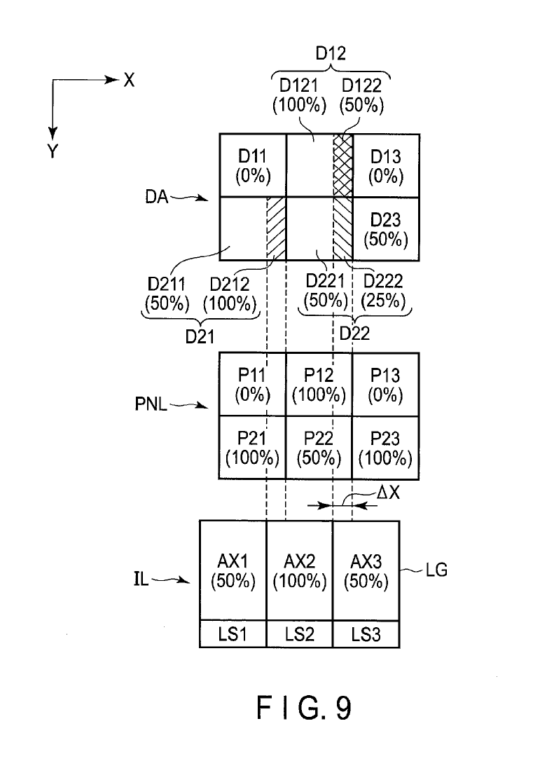

As shown in FIG. 8(b), the brightness distribution of the illumination device IL is shifted relative to the transmittance distribution of the display panel PNL in the first direction X, as compared to the example illustrated in FIG. 6. Accordingly, the brightness distribution along line A-A of the display area DA does not become uniform. Such a phenomenon will be described in more detail by referring to FIG. 9.

FIG. 9 is an illustration for explaining each portion of the display device DSP shown in FIG. 8. Here, it is assumed that the illumination device IL and the display panel PNL are displaced from each other in the first direction X by displacement amount ΔX, but are not displaced from each other in the second direction Y.

Similarly to the example illustrated in FIG. 7, the brightness levels of illumination portions AX1 and AX3 are each set to 50%, and the brightness level of illumination portion AX2 is set to 100%. The transmittance of each of display portions P11 and P13 is set to 0%, the transmittance of each of display portions P12, P21, and P23 is set to 100%, and the transmittance of display portion P22 is set to 50%.

The brightness levels of regions D11 and D13 are 0% because the transmittances of the corresponding display portions P11 and P13 are 0%. The brightness level of region D23 is 50% because the transmittance of the corresponding display portion P23 is 100%, and the brightness level of illumination portion AX3 is 50%. Desired brightness levels are obtained in these regions, as in the case where the displacement amount ΔX is zero.

In region D12, the brightness level of sub-region D121 is 100% because the transmittance of the corresponding display portion P12 is 100%, and the brightness level of illumination portion AX2 is 100%. Meanwhile, the brightness level of sub-region D122 is 50% because the transmittance of the corresponding display portion P12 is 100%, but this region overlaps illumination portion AX3 whose brightness level is 50%, so the brightness level becomes 50%.

In region D21, the brightness level of sub-region D211 is 50% because the transmittance of the corresponding display portion P21 is 100%, and the brightness level of illumination portion AX1 is 50%. Meanwhile, the brightness level of sub-region D212 is 100% because the transmittance of the corresponding display portion P21 is 100%, but this region overlaps illumination portion AX2 whose brightness level is 100%, so the brightness level becomes 100%.

In region D22, the brightness level of sub-region D221 is 50% because the transmittance of the corresponding display portion P22 is 50%, and the brightness level of illumination portion AX2 is 100%. Meanwhile, the brightness level of sub-region D222 is 25% because the transmittance of the corresponding display portion P22 is 50%, but this region overlaps illumination portion AX3 whose brightness level is 50%, so the brightness level becomes 25%.

As can be seen, when displacement by displacement amount ΔX occurs in the first direction X, a single region which should essentially have the same brightness level is composed of two sub-regions having different brightness levels. Thus, a desired brightness level cannot be obtained in these sub-regions.

The brightness distribution of the inspection screen described with reference to FIGS. 8 and 9 corresponds to a second brightness distribution which is to be measured when measuring displacement amount ΔX in step ST12 explained with reference to FIG. 5. Further, the second brightness distribution is compared with the first brightness distribution described above. Furthermore, the displacement amount ΔX is measured by a difference between the first brightness distribution and the second brightness distribution.

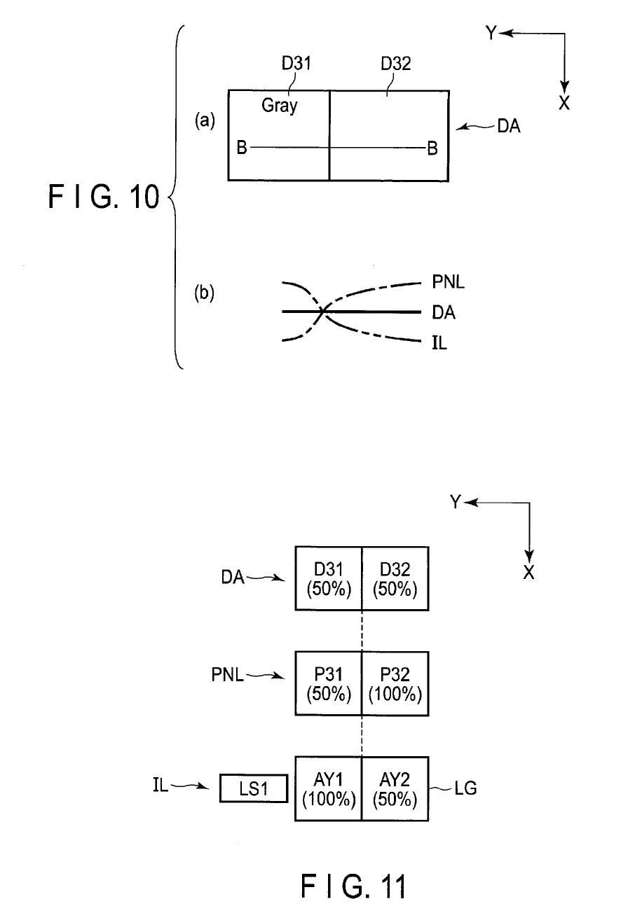

FIG. 10 is an illustration showing the state in which the inspection screen is displayed on the display device DSP where displacement amount ΔY is zero. FIG. 10(a) is an illustration showing the display area DA in which the inspection screen is displayed, and FIG. 10(b) is an illustration showing each of the brightness distribution along line B-B of the display area DA shown in FIG. 10(a) (indicated by a solid line), the brightness distribution of the illumination device IL (indicated by a one-dot chain line), and the transmittance distribution of the display panel PNL (indicated by a two-dot chain line).

The display area DA includes regions D31 and D32 arranged in the second direction Y. In a state in which the inspection screen is displayed in the display are DA, a gray image (halftone value) is displayed (realized) in regions D31 and D32.

The illumination device IL controls the brightness level of light directed toward regions D31 and D32 in order to display the gray image in regions D31 and D32. At this time, when regions D31 and D32 have a brightness distribution of different brightness levels along the second direction Y, the display panel PNL is controlled to have a transmittance in consideration of the brightness level of the illumination device IL. Thereby, regions D31 and D32 show a gray image of a substantially uniform brightness distribution. Such control will be explained specifically with reference to FIG. 11.

FIG. 11 is an illustration for explaining each portion of the display device DSP shown in FIG. 10. Here, parts in the X-Y plane are depicted schematically for each of the illumination device IL, the display panel PNL, and the display area DA. The illumination device IL comprises illumination portions AY1 and AY2 arranged in the second direction Y. It is assumed that light source LS1 emits light toward the light-guide LG in a direction opposite to that indicated by the arrow representing the second direction Y, and illuminates illumination portions AY1 and AY2. The display panel PNL comprises display portions P31 and P32 arranged in the second direction Y. Each of these display portions P31 and P32 is composed of a plurality of pixels PX arrayed in a matrix, as has been explained referring to FIG. 3, etc. Display portion P31 overlaps illumination portion AY1, and is illuminated by illumination portion AY1. Display portion P32 overlaps illumination portion AY2, and is illuminated by illumination portion AY2.

In one example, a brightness level of illumination portion AY1 is set to 100%, and a brightness level of illumination portion AY2 is set to 50%. A transmittance of display portion P31 is set to 50%, and a transmittance of display portion P32 is set to 100%.

A brightness level of region D31 is 50% because the transmittance of the corresponding display portion P31 is 50%, and the brightness level of illumination portion AY1 is 100%. A brightness level of region D32 is 50% because the transmittance of the corresponding display portion P32 is 100%, and the brightness level of illumination portion AY2 is 50%. Consequently, a gray image corresponding to a halftone is displayed in regions D31 and D32, and the brightness levels of regions D31 to D32 become uniform.

As can be seen, the brightness distribution of the inspection screen explained with reference to FIGS. 10 and 11 corresponds to a third brightness distribution obtained when displacement amount ΔY, which is measured in step ST12 explained referring to FIG. 5, is zero, and this third brightness distribution can be used as a criterion in measuring displacement amount ΔY.

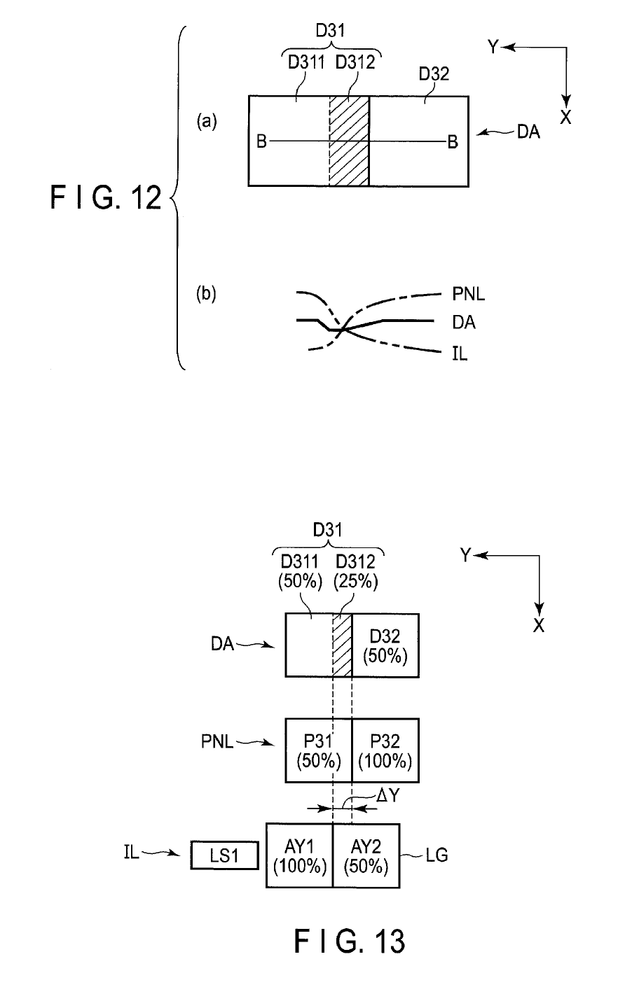

FIG. 12 is an illustration showing the state in which the inspection screen is displayed on the display device DSP in which the illumination device IL and the display panel PNL are displaced from each other in the second direction Y. FIG. 12(a) is an illustration showing the display area DA in which the inspection screen is displayed, and FIG. 12(b) is an illustration showing each of the brightness distribution along line B-B of the display area DA shown in FIG. 12(a) (indicated by a solid line), the brightness distribution of the illumination device IL (indicated by a one-dot chain line), and the transmittance distribution of the display panel PNL (indicated by a two-dot chain line).

As shown in FIG. 12(a), region D31 includes sub-regions D311 and D312. Sub-region D312 is adjacent to region D32. In the example illustrated, a gray image is displayed in each of sub-region D311 and region D32. Meanwhile, an image of a gradation value different from that of the gray image is displayed in sub-region D312.

As shown in FIG. 12(b), the brightness distribution of the illumination device IL is shifted relative to the transmittance distribution of the display panel PNL in the second direction Y, as compared to the example illustrated in FIG. 10. Accordingly, the brightness distribution along line B-B of the display area DA does not become uniform. Such a phenomenon will be described in more detail by referring to FIG. 13.

FIG. 13 is an illustration for explaining each portion of the display device DSP shown in FIG. 12. Here, it is assumed that the illumination device IL and the display panel PNL are displaced from each other in the second direction Y by displacement amount ΔY, but are not displaced from each other in the first direction X.

Similarly to the example illustrated in FIG. 11, the brightness level of illumination portion AY1 is set to 100%, and the brightness level of illumination portion AY2 is set to 50%. The transmittance of display portion P31 is set to 50%, and the transmittance of display portion P32 is set to 100%.

The brightness level of region D32 is 50% because the transmittance of the corresponding display portion P32 is 100%, and the brightness level of illumination portion AY2 is 50%. That is, in region D32, a desired brightness level is obtained as in the case where the displacement amount ΔY is zero.

In region D31, the brightness level of sub-region D311 is 50% because the transmittance of the corresponding display portion P31 is 50%, and the brightness level of illumination portion AY1 is 100%. Meanwhile, the brightness level of sub-region D312 is 25% because the transmittance of the corresponding display portion P31 is 50%, but this region overlaps illumination portion AY2 whose brightness level is 50%, so the brightness level becomes 25%.

As can be seen, also in a case where displacement by displacement amount ΔY occurs in the second direction Y, a single region which should essentially have the same brightness level is composed of two sub-regions having different brightness levels. Thus, a desired brightness level cannot be obtained in these sub-regions.

The brightness distribution of the inspection screen described with reference to FIGS. 12 and 13 corresponds to a fourth brightness distribution which is to be measured when measuring displacement amount ΔY in step ST12 explained with reference to FIG. 5. Further, the fourth brightness distribution is compared with the third brightness distribution described above. Furthermore, the displacement amount ΔY is measured by a difference between the third brightness distribution and the fourth brightness distribution. Adjustment parameters based on these displacement amounts ΔX and ΔY are stored in the memory 112 of the display device DSP.

Next, one example of a method of driving the display device DSP in which the adjustment parameters are stored, based on the measurement of the above displacement amount, will be described.

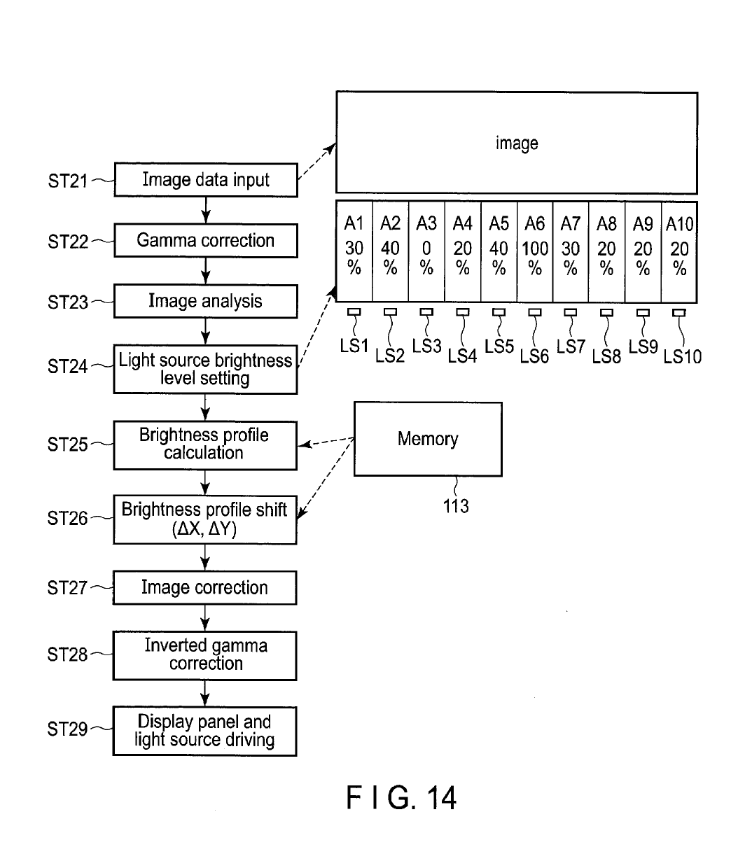

FIG. 14 is an illustration for explaining a method of driving the display device DSP according to the present embodiment. The display device DSP performs processing described below for each frame for displaying one screen on the display area DA.

First, image data is input to the controller 100 (step ST21). The image data is data necessary for displaying an image as illustrated in the drawing. The image may include a bright portion (a high gradation portion) and a dark portion (a low gradation portion). The image data may include, for example, red (R) data corresponding to red, green (G) data corresponding to green, and blue (B) data corresponding to blue, in order to realize color display.

Next, the controller 100 performs various kinds of processing in the signal processor 110, on the basis of the input image data. More specifically, the image processor 111 performs gamma correction for the input image data, and linearizes the image data (step ST22). Further, the image processor 111 generates a video signal for driving each pixel PX based on the linearized image data, and also performs image analysis processing (step ST23). In the image analysis processing, a brightness level is calculated for each block obtained by dividing the image of a size of one screen, on the basis of the image data. In the example illustrated, the image of a size of one screen is divided into ten blocks, which are blocks A1 to A10. Blocks A1 to A10 correspond to areas illuminated by light sources LS1 to LS10, respectively. In one example, brightness levels of blocks A1 to A10 are calculated in scales from 0 to 100%, respectively. As illustrated in the drawing, for example, the brightness level of block A3 which is constituted of only the dark portion of the minimum gradation value is 0%, and the brightness level of block A6 including the bright portion of the maximum gradation value is 100%. Also for the other blocks, the brightness level is set in accordance with a bright portion having the highest gradation value in the block, for example.

Next, the image processor 111 sets the brightness level for each of light sources LS1 to LS10 (step ST24). In one example, the brightness levels of light sources LS1 to LS10 are set to be equal to the brightness levels of blocks A1 to A10 calculated in step ST23. As illustrated in the drawing, for example, the brightness level of light source LS3 which illuminates block A3 is set to 0%, and the brightness level of light source LS6 which illuminates block A6 is set to 100%. For all of the other light sources, the brightness levels are set to be equal to the brightness levels of the blocks to be illuminated.

Next, the image processor 111 reads the brightness distribution data corresponding to the respective brightness levels of light sources LS1 to LS10, and calculates a brightness profile (step ST25). In the memory 112, the brightness distribution data corresponding to brightness levels of 0 to 100% regarding light source LS1 is stored, and the brightness distribution data corresponding to the respective brightness levels is similarly stored for the other light sources LS2 to LS10.

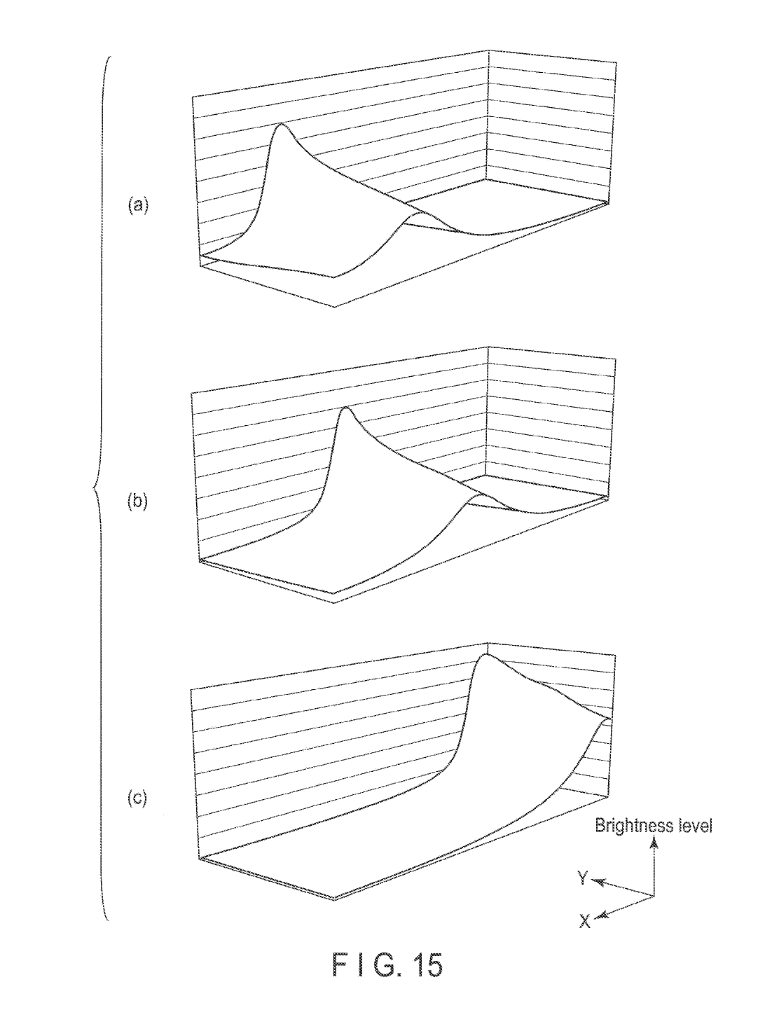

FIG. 15 shows an example of the brightness distribution data stored in the memory 112. FIG. 15(a) represents the brightness distribution data in the X-Y plane when light source LS3 is set at the brightness level of 100%. FIG. 15(b) represents the brightness distribution data in the X-Y plane when light source LS5 is set at the brightness level of 100%. FIG. 15(c) represents the brightness distribution data in the X-Y plane when light source LS10 is set at the brightness level of 100%. As illustrated in the drawing, even if light source LS10 located at an edge of the illumination device IL is set at the same brightness level as the brightness levels of light source LS2 to LS9, the maximum brightness level of light source LS10 is different from the maximum brightness level of each of light sources LS2 to LS9. In order to realize a uniform brightness level throughout the entire area of the illumination device IL, it is necessary to consider the effect of light from the adjacent light sources. Light source LS9 is arranged adjacent to light source LS10 located at the edge on only one side of light source LS10, and light source LS10 is affected by this light source LS9 alone. Meanwhile, with respect to light sources LS2 to LS9, the light sources are arranged on both sides of these light sources. For example, light source LS3 is affected by two adjacent light sources LS2 and LS4. Accordingly, when light sources LS1 to LS10 are set at the same brightness level, in order to realize a uniform brightness level throughout the entire area of the illumination device IL, the maximum brightness level of each of light sources LS1 and LS10 must be set higher than the maximum brightness level of each of the other light sources LS2 to LS9. The maximum brightness level of light source LS1 is equal to the maximum brightness level of light source LS10 shown in FIG. 15(c). The maximum brightness level of light sources LS2 to LS9 is equal to the maximum brightness level shown in FIG. 15(a) and FIG. 15(b). Although explanation has been given for the brightness distribution data regarding each of the light sources when the brightness level is 100% in the above, the brightness distribution data regarding each of the light sources for the other brightness levels is also stored in the memory 112.

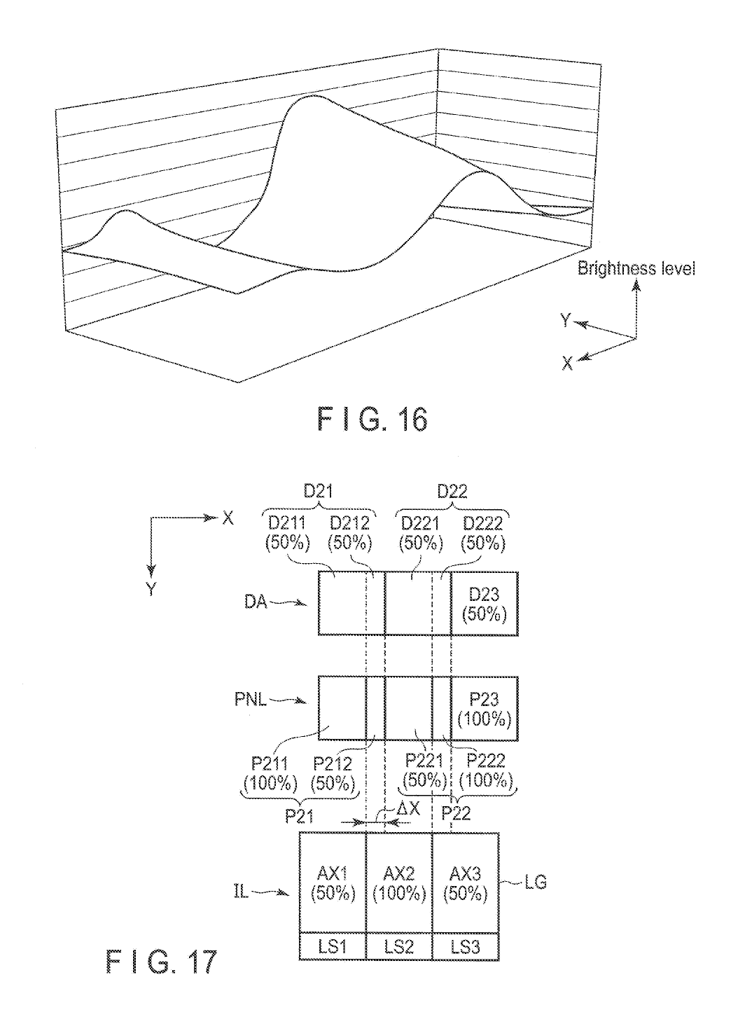

Further, the image processor 111 calculates the brightness profile of the illumination device IL on the basis of the brightness distribution data regarding each of light sources LS1 to LS10 read from the memory 112. FIG. 16 is an illustration showing one example of the brightness profile calculated by the image processor 111. The brightness profile corresponds to an element created by integrating the brightness levels at the respective positions in the X-Y plane of the illumination device IL.

Next, the image processor 111 reads the adjustment parameters corresponding to displacement amount ΔX and displacement amount ΔY from the memory 112, and shifts a correlation between the calculated brightness profile and the display portion P of the display panel PNL in the X-Y plane (step ST26). For example, when displacement by displacement amount ΔX occurs, as shown in FIG. 9, a correlation between the positions of illumination portions AX1 to AX3 for obtaining the calculated brightness profile and the positions of display portions P11 to P13 and P21 to P23 of the display panel PNL is shifted in the first direction X by an amount corresponding to displacement amount ΔX. Also, when displacement by displacement amount ΔY occurs, as shown in FIG. 13, a correlation between the positions of illumination portions AY1 and AY2 for obtaining the calculated brightness profile and the positions of display portions P31 and P32 of the display panel PNL is shifted in the second direction Y by an amount corresponding to displacement amount ΔY. The specific examples of the above will be described later.

Next, the image processor 111 performs image correction in accordance with a shift amount of the illumination portion and the display portion (step ST27). That is, after a video signal for each of the pixels PX has been generated from the input image data, the image processor 111 performs image correction such as decompression of the video signal based on the brightness level of the illumination device IL according to need, and generates a corrected video signal. The image correction as described above is performed when a relative displacement between the illumination portion and the display portion along the first direction X and the second direction Y occurs, and image correction is performed as appropriate in consideration of displacement amounts ΔX and ΔY. In other words, the video signal generated from the input image data is premised on that displacement amounts ΔX and ΔY are both zero. Accordingly, the video signal of each pixel is generated by performing correction such as performing decompression as appropriate in accordance with the brightness level of the brightness profile at a position of the pixel in question. The corrected video signal of each pixel is generated by performing correction as appropriate according to the brightness level of the brightness profile at the position of the pixel in question after shifting the brightness profile based on displacement amounts ΔX and ΔY. In this way, the pixel PX, which is illuminated at a brightness level different from that set when displacement amounts ΔX and ΔY are zero, is driven by a newly generated corrected video signal.

Note that when the input image data includes red (R) data corresponding to red (R), green (G) data corresponding to green, and blue (B) data corresponding to blue, a signal for each of a red pixel, a green pixel, and a blue pixel is generated, as a video signal or a corrected video signal. However, in addition to the aforementioned signals, a signal for a white pixel may be generated.

Next, the image processor 111 performs inverted gamma correction for the generated corrected video signal (step ST28).

Next, the signal processor 110 outputs a control signal including a video signal or a corrected video signal and a synchronization signal to the panel driver 120, and also outputs a control signal including a drive signal and a synchronization signal to the light source driver 130. The panel driver 120 drives the display panel PNL based on the control signal. Also, the light source driver 130 drives the light sources LS based on the control signal (step ST29).

FIG. 17 is an illustration for explaining the state in which the positional relationship between the illumination portion and the display portion is shifted in the first direction X. Here, parts in the X-Y plane are depicted schematically for each of the illumination device IL, the display panel PNL, and the display area DA. The example illustrated here corresponds to an example of image correction applicable when displacement by displacement amount ΔX shown in FIGS. 8 and 9 occurs.

In the illumination device IL, illumination portions AX1 to AX3 are arranged in the first direction X. Light source LS1 which emits light toward illumination portion AX1, light source LS2 which emits light toward illumination portion AX2, and light source LS3 which emits light toward illumination portion AX3 are arranged in the first direction X.

Display portion P21 includes sub-display portions P211 and P212 arranged in the first direction X. Display portion P22 includes sub-display portions P221 and P222 arranged in the first direction X. Sub-display portion P211 overlaps illumination portion AX1, sub-display portions P212 and P221 overlap illumination portion AX2, and sub-display portion P222 and display portion P23 overlap illumination portion AX3. The brightness levels of illumination portions AX1 to AX3 are the same as those of the example illustrated in FIG. 7.

When the displacement amount ΔX is zero, sub-display portion P212 overlaps illumination portion AX1. Accordingly, a video signal of each pixel which constitutes sub-display portion P212 is generated based on the brightness level of 50% set for illumination portion AX1. However, when displacement by displacement amount ΔX occurs, sub-display portion P212 overlaps illumination portion AX2, and the brightness level of illumination portion AX2 is different from the brightness level of illumination portion AX1. A width of sub-display portion P212 along the first direction X is equal to displacement amount ΔX along the first direction X. Accordingly, a corrected video signal of each pixel which constitutes sub-display portion P212 is generated based on the brightness level of 100% set for illumination portion AX2, in an image correction step shown in FIG. 14 (step ST27). In the example illustrated, the transmittance of sub-display portion P212 is set to 50%. Note that sub-display portion P211 overlaps illumination portion AX1, as in the case where the displacement amount ΔX is zero. Thus, the transmittance of sub-display portion P211 is set to 100%, as in the case where the displacement amount ΔX is zero.

Similarly, while sub-display portion P222 overlaps illumination portion AX2 when the displacement amount ΔX is zero, sub-display portion P222 overlaps illumination portion AX3 in the example illustrated. Moreover, the brightness level of illumination portion AX3 is different from the brightness level of illumination portion AX2. Accordingly, a corrected video signal of each pixel which constitutes sub-display portion P222 is generated based on the brightness level of 50% set for illumination portion AX3. In the example illustrated, the transmittance of sub-display portion P222 is set to 100%. Note that sub-display portion P221 overlaps illumination portion AX2, as in the case where the displacement amount ΔX is zero. Thus, the transmittance of sub-display portion P221 is set to 50%, as in the case where the displacement amount ΔX is zero.

In region D21, the brightness level of sub-region D211 is 50% because the transmittance of the corresponding sub-display portion P211 is 100%, and the brightness level of illumination portion AX1 is 50%. Also, the brightness level of sub-region D212 is 50% because the transmittance of the corresponding sub-display portion P212 is 50%, and this region overlaps illumination portion AX2 whose brightness level is 100%, so the brightness level becomes 50%.

In region D22, the brightness level of sub-region D221 is 50% because the transmittance of the corresponding sub-display portion P221 is 50%, and the brightness level of illumination portion AX2 is 100%. Also, the brightness level of sub-region D222 is 50% because the transmittance of the corresponding sub-display portion P222 is 100%, and this region overlaps illumination portion AX3 whose brightness level is 50%, so the brightness level becomes 50%.

The brightness level of region D23 is 50% because the transmittance of the corresponding display portion P23 is 100%, and the brightness level of illumination portion AX3 is 50%. As a result, a gray image corresponding to a halftone is displayed over the entire regions of D21 to D23, and the brightness levels of regions D21 to D23 become uniform.

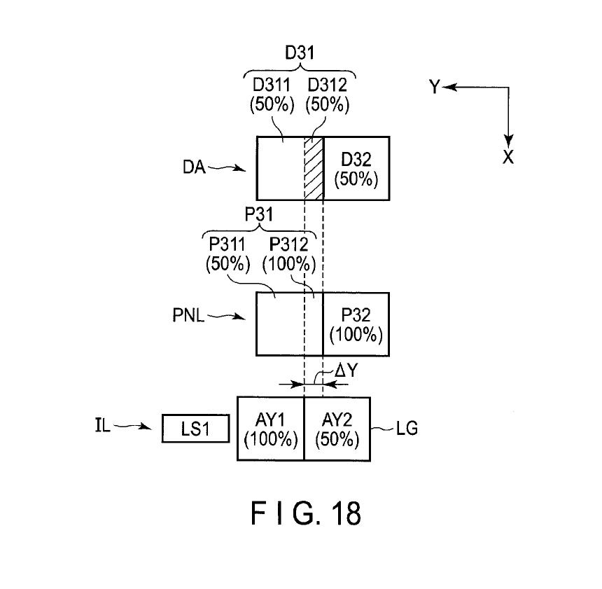

FIG. 18 is an illustration for explaining the state in which the positional relationship between the illumination portion and the display portion is shifted in the second direction Y. The example illustrated here corresponds to an example of image correction applicable when displacement by displacement amount ΔY shown in FIGS. 12 and 13 occurs.

In the illumination device IL, illumination portions AY1 and AY2 are arranged in the second direction Y. Light source LS1 emits light toward illumination portions AY1 and AY2.

Display portion P31 includes sub-display portions P311 and P312 arranged in the second direction Y. Sub-display portion P311 overlaps illumination portion AY1, and sub-display portion P312 and display portion P32 overlap illumination portion AY2. The brightness levels of illumination portions AY1 and AY2 are the same as those of the example illustrated in FIG. 13.

When the displacement amount ΔY is zero, sub-display portion P312 overlaps illumination portion AY1. Accordingly, a video signal of each pixel which constitutes sub-display portion P312 is generated based on the brightness level of 100% set for illumination portion AY1. However, when displacement by displacement amount ΔY occurs, sub-display portion P312 overlaps illumination portion AY2, and the brightness level of illumination portion AY2 is different from the brightness level of illumination portion AY1. A width of sub-display portion P312 along the second direction Y is equal to displacement amount ΔY along the second direction Y. Accordingly, a corrected video signal of each pixel which constitutes sub-display portion P312 is generated based on the brightness level of 50% set for illumination portion AY2, in an image correction step shown in FIG. 14 (step ST27). In the example illustrated, the transmittance of sub-display portion P312 is set to 100%. Note that sub-display portion P311 overlaps illumination portion AY1, as in the case where the displacement amount ΔY is zero. Thus, the transmittance of sub-display portion P311 is set to 50%, as in the case where the displacement amount ΔY is zero.

In region D31, the brightness level of sub-region D311 is 50% because the transmittance of the corresponding sub-display portion P311 is 50%, and the brightness level of illumination portion AY1 is 100%. Also, the brightness level of sub-region D312 is 50% because the transmittance of the corresponding sub-display portion P312 is 100%, and this region overlaps illumination portion AY2 whose brightness level is 50%, so the brightness level becomes 50%.

The brightness level of region D32 is 50% because the transmittance of the corresponding display portion P32 is 100%, and the brightness level of illumination portion AY2 is 50%. As a result, a gray image corresponding to a halftone is displayed over the entire regions of D31 and D32, and the brightness levels of regions D31 and D32 become uniform.

As described above, according to the present embodiment, in a method of controlling the brightness of the illumination device for each of the light sources based on input image data, even if the illumination device and the display panel are displaced from each other in at least one of the first direction X and the second direction Y, the brightness of the display panel can be adjusted in units of one pixel by using the adjustment parameter according to the displacement amount, and the display quality can be improved. In other words, when the illumination device and the display panel are fixed, a margin of permissible amount of displacement can be increased, and thus the manufacturing yield can be improved or the manufacturing cost can be reduced.

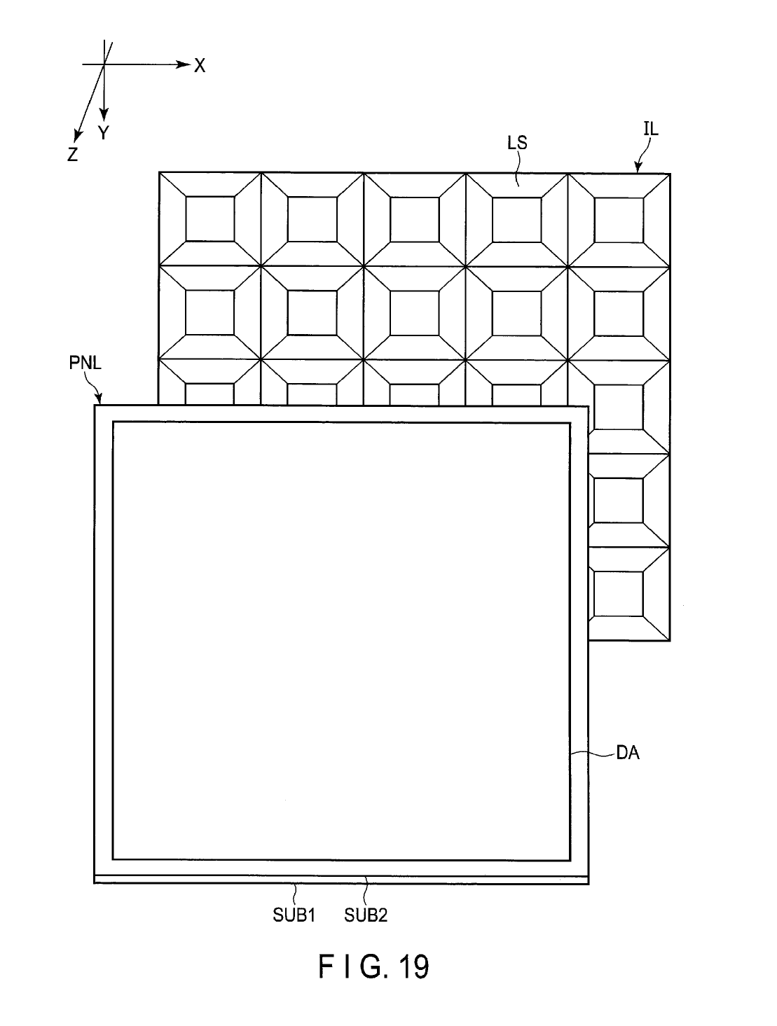

FIG. 19 is an illustration showing another configuration example of the illumination device IL and the display panel PNL which can be applied to the present embodiment. In the above configuration example, while an edge-light-type system in which the light source emits light toward a side surface of the light-guide has been adopted in the illumination device IL, the illumination device IL is not particularly limited to this example.

The illumination device IL is arranged on a back surface of the display panel PNL, and irradiates light toward the display panel PNL. The illumination device IL comprises light sources LS arrayed in a matrix in the first direction X and the second direction Y. These light sources LS are disposed at positions opposed to the display area DA. In one example, one light source LS is arranged to be opposed to a display portion or a sub-display portion composed of a plurality of pixels PX. Turning on and off of the light sources LS, and the brightness levels of the light sources LS can be controlled individually.

Also in a display device to which such an illumination device IL is applied, likewise the configuration example described above, an amount of displacement between the illumination device IL and the display panel PNL is measured, and an adjustment parameter according to the displacement amount is stored in the display device. Thereby, the brightness of the display panel PNL can be controlled in units of one pixel. Accordingly, an advantage similar to that of the above-described configuration example can be obtained.

In the present embodiment described above, the display panel PNL is a transmissive liquid crystal panel, and the illumination device IL is a backlight unit located on a back surface of the display panel PNL. However, the combination of elements is not limited to the ones described above. For example, the display panel PNL may be a reflective liquid crystal panel, and the illumination device IL may be a front light unit located on a front surface of the display panel PNL. Even if displacement between the reflective liquid crystal panel and the front light unit occurs, since each of the pixels is driven by a corrected video signal in a display portion in a range according to the displacement amount, the reflectivity of each pixel is corrected and an advantage similar to that of the above embodiment can be obtained.

As described above, according to the present embodiment, a display device which can improve the display quality, a method of driving the display device, and a method of inspecting the display device can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Further, even if structural elements in the claims are expressed as divided elements, added elements, or combined elements, these elements still fall within the scope of the present disclosure.

What is claimed is:

1. A display device comprising:
an illumination device comprising a first illumination portion and a second illumination portion which are adjacent to each other;
a display panel comprising a first display portion illuminated by the first illumination portion, and a second display portion illuminated by the second illumination portion, the display panel being fixed to the illumination device; and
a controller which controls the illumination device and the display panel, wherein
the first display portion includes a first sub-display portion, and a second sub-display portion adjacent to the second display portion, and
the controller controls a modulation rate of the second sub-display portion of the first display portion, based on an amount of displacement between the illumination device and the display panel.

2. The display device of claim 1, wherein the illumination device comprises a first light source which emits light toward the first illumination portion, and a second light source which emits light toward the second illumination portion, and
the first illumination portion and the second illumination portion are arranged in a first direction.

3. The display device of claim 2, wherein:
the first sub-display portion and the second sub-display portion are arranged in the first direction, and
a width of the second sub-display portion along the first direction is equal to the amount of displacement along the first direction.

4. The display device of claim 1, wherein the illumination device comprises a single light source which emits light toward the first illumination portion and the second illumination portion, and
the first illumination portion and the second illumination portion are arranged in a second direction.

5. The display device of claim 4, wherein:
the first sub-display portion and the second sub-display portion are arranged in the second direction, and
a width of the second sub-display portion along the second direction is equal to the amount of displacement along the second direction.

6. The display device of claim 1, wherein the controller generates a first video signal for driving the first display portion and a second video signal for driving the second display portion, based on a first brightness level of the first illumination portion necessary for displaying an image on the first display portion, a second brightness level of the second illumination portion necessary for displaying an image on the second display portion, and the amount of displacement.

7. The display device of claim 6, wherein:
the first sub-display portion overlaps the first illumination portion;
the second sub-display portion and the second display portion overlap the second illumination portion; and
the controller generates a corrected video signal for driving the second sub-display portion, based on the second brightness level.

8. A method of driving a display device, the display device comprising:
an illumination device comprising a first illumination portion and a second illumination portion which are adjacent to each other; and
a display panel comprising a first display portion illuminated by the first illumination portion, and a second display portion illuminated by the second illumination portion,
the first display portion including a first sub-display portion, and a second sub-display portion adjacent to the second display portion,
the method of driving the display device comprising
controlling a modulation rate of the second sub-display portion of the first display portion, based on an amount of displacement between the illumination device and the display panel.

9. The method of claim 8, wherein the controlling the modulation rate includes:
setting each of a first brightness level of the first illumination portion necessary for displaying an image on the first display portion, and a second brightness level of the second illumination portion necessary for displaying an image on the second display portion;
generating a first video signal for driving the first display portion and a second video signal for driving the second display portion, based on the first and second brightness levels, and the amount of displacement;
generating a corrected video signal for driving the second sub-display portion, based on the second brightness level; and
driving the second sub-display portion based on the corrected video signal.

10. A method of inspecting a display device, the method comprising:
displaying an inspection screen on the display device including an illumination device and a display panel fixed to the illumination device;
measuring an amount of displacement between the illumination device and the display panel based on a brightness distribution of the displayed inspection screen; and
writing an adjustment parameter based on the amount of displacement to the display device,
the displaying the inspection screen including:
setting a first illumination portion of the illumination device to a first brightness level, and setting a second illumination portion adjacent to the first illumination portion to a second brightness level; and
driving a first display portion of the display panel based on a first video signal, and driving a second display portion adjacent to the first display portion based on a second video signal, wherein
the first brightness level is different from the second brightness level, and the first video signal is different from the second video signal.
